(19) United States
(12) Patent Application Publication
(10) Pub. No.: US 2026/0160319 A1
(43) Pub. Date: Jun. 11, 2026

(54) LOCKING DIFFERENTIAL

(71) Applicant: The Regents of the University of Michigan, Ann Arbor, MI (US)

(72) Inventor: Benjamin V. WU, Belvedere, CA (US)

(21) Appl. No.: 19/373,203

(22) Filed: Oct. 29, 2025

Related U.S. Application Data
(60) Provisional application No. 63/713,571, filed on Oct. 29, 2024.

(51) Int. Cl. F16H 48/24; F16H 48/10

(52) U.S. Cl. CPC F16H 48/24; F16H 48/10; F16H 2048/106

(57) ABSTRACT

A locking differential includes a gear train coupling an input shaft to first and second output shafts such that the output shafts are permitted to rotate at different speeds when the differential is in an unlocked condition and are restricted to rotate at the same speed when the differential is in a locked condition. The gear train includes a pair of planetary gear sets with spur gears as the sun and planet gears and with the planet gears of each set being intermeshed. An axially movable lock engages the face of one of the sun gears to place the differential in the locked condition. The combination of spur gears and a lock that overlaps axially with one of the sun gears in the locked condition provide the differential with an exceptionally low axial profile.

### TECHNICAL FIELD

This disclosure is related to mechanical differentials and, more particularly, to locking differentials.

### BACKGROUND

Differentials of the type often used in vehicle powertrains have one input shaft driven by the vehicle power source and two output shafts, each of which turns a drive wheel on opposite sides of the vehicle. The differential typically includes a gear set that permits the two output shafts to rotate at different speeds. When the vehicle is making a turn, this permits the wheel on the outside of the turn to rotate faster than the wheel on the inside of the turn. Otherwise, with a solid drive axle, undo stress is placed on the axle, and the wheel on the inside of the turn is often forced to intermittently lose traction to match the rotation of the opposite wheel. One long-time problem with differentials occurs when one of the drive wheels encounters a low- or no-traction condition (e.g., ice or lost ground contact) while the opposite drive wheel maintains traction. In that scenario, a traditional differential will cause the low traction wheel to spin while the opposite wheel remains idle, resulting in loss of propulsion.

Limited-slip differentials were developed to counter this problem. These types of differentials work on various different principles but are generally configured to send some of the incoming power to the wheel with more traction when the low-traction wheel begins to spin faster than the high-traction wheel. In some vehicle applications, it is desirable to have a locking differential, which normally functions as a traditional differential but is changeable to a fully locked condition in which both output shafts are forced to rotate at the same speed—as if a solid axle with no differential. Locking differentials may be used with vehicles intended for both on-road and off-road use, where rough off-road terrain can cause a drive wheel to lose ground contact or intermittent wet conditions can cause one wheel to lose traction while the other wheel maintains traction.

Traditional vehicle differentials employ bevel gears in a box-like arrangement, with two bevel gears driving the two output shafts and two more bevel gears as planet gears orbiting the common output shaft axis. A problem with traditional bevel-gear differentials is the large volume required for packaging the gear set. Such large packaging spaces are tolerable for most vehicle applications due to the large packaging envelope available beneath the vehicle. But not all applications have the luxury of a large packaging envelope.

### SUMMARY

Embodiments of a locking differential include a gear train operatively coupling an input shaft to first and second output shafts. The gear train includes first and second spur gears fixed to the respective first and second output shafts such that the spur gears are permitted to rotate at different speeds when the differential is in an unlocked condition and are restricted to rotate at the same speed when the differential is in a locked condition.

The locking differential may include any one or more of the following features in any technically feasible combination:
a plurality of spur gears each transmitting power from the input shaft to the first and second spur gears;
a first set of planetary gears that includes a first spur gear as a first sun gear and a first planet gear intermeshed with the first sun gear, a second set of planetary gears that includes a second spur gear as a second sun gear and a second planet gear intermeshed with the second sun gear, and a carrier operatively coupled with an input shaft, wherein: the carrier carries the first and second planet gears in orbit about an output axis of the differential when an input shaft rotates about an input axis of the differential, the first planet gear is intermeshed with the second planet gear, and each planet gear is a spur gear;
a lock that is movable between an unlocked position, in which first and second sun gears are permitted to rotate about an output axis independently from a carrier, and a locked position, in which the first and second sun gears are restricted to rotate about the output axis with the carrier;
a lock that is movable in an axial direction between unlocked and locked positions and that engages a face of a sun gear in the locked position;
at least one protrusion along the face of a sun gear and received by a slot of an axially movable lock when the lock is in a locked position;
a locking plate and a slot formed through the locking plate;
a lock that is movable along one or more guide posts between unlocked and locked positions, each guide post rigidly interconnecting opposite first and second portions of a planet gear carrier;
a locking plate having one or more guide openings formed therethrough with a guide post extending through one of the guide openings;
a locking plate that rotates with a carrier about an output axis, the locking plate engaging a sun gear in a locked position and engaging no sun gear in an unlocked position;
a plurality of openings formed through a locking plate, at least one of the openings receiving a protrusion of an engaged sun gear in a locked position, at least one of the openings having a guide post extending therethrough, and at least one of the openings having a shaft of a planet gear extending therethrough;
a shifter that moves a lock between unlocked and locked positions, wherein the lock rotates with a carrier and the shifter does not rotate with the lock or carrier;
a locking plate and a shifter located at a perimeter of the locking plate that engages the locking plate at the perimeter to move the locking plate between unlocked and locked positions;
a shifter having a C-shape when viewed in an axial direction of an output shaft and extending circumferentially around a portion of a perimeter of a locking plate;
the gear train does not include a bevel gear; and/or
a radially inner portion of a shifter received in a groove extending along a perimeter of a locking plate.

### BRIEF DESCRIPTION OF THE DRAWINGS

FIG. 1 is an exploded view of an example of a spur-gear locking differential.

FIG. 2 is a perspective view of the locking differential of FIG. 1 with a portion of the housing omitted.

FIG. 3 is the same perspective view as in FIG. 2 with a first carrier portion and a locking mechanism additionally omitted.

FIG. 4 is a side view of first and second sets of planetary gears of the differential of FIGS. 1-3.

FIG. 5 is a perspective view of the sets of planetary gears of FIG. 4.

FIG. 6 is the same perspective view of as in FIG. 3 with the locking mechanism additionally illustrated.

FIG. 7 is a side view of a portion of the locking differential of FIG. 1 in an unlocked condition.

FIG. 8 is the same side view as in FIG. 7 with the locking differential in a locked condition.

### DESCRIPTION OF EMBODIMENTS

Described below is a locking differential in which every gear within the gear train may be a spur gear. A spur gear is a cylindrical gear having a cylindrical pitch surface and a tooth line which is straight and parallel with the gear shaft or gear axis of rotation. Spur gears have several advantages over other gears (e.g., bevel gears, helical gears, etc.), including high accuracy, ease of manufacture, the absence of thrust forces, and a relatively thin profile. While other gear types such as helical bevel gears have their own advantages, such as higher load capability and quieter operation, those advantages come with trade-offs, and not all applications are concerned with characteristics like quiet operation. Where packaging space is at a premium and the application is cost sensitive, spur gears may be preferred. However, development of locking differentials has been largely limited to the traditional bevel-gear constructions associated with automotive applications.

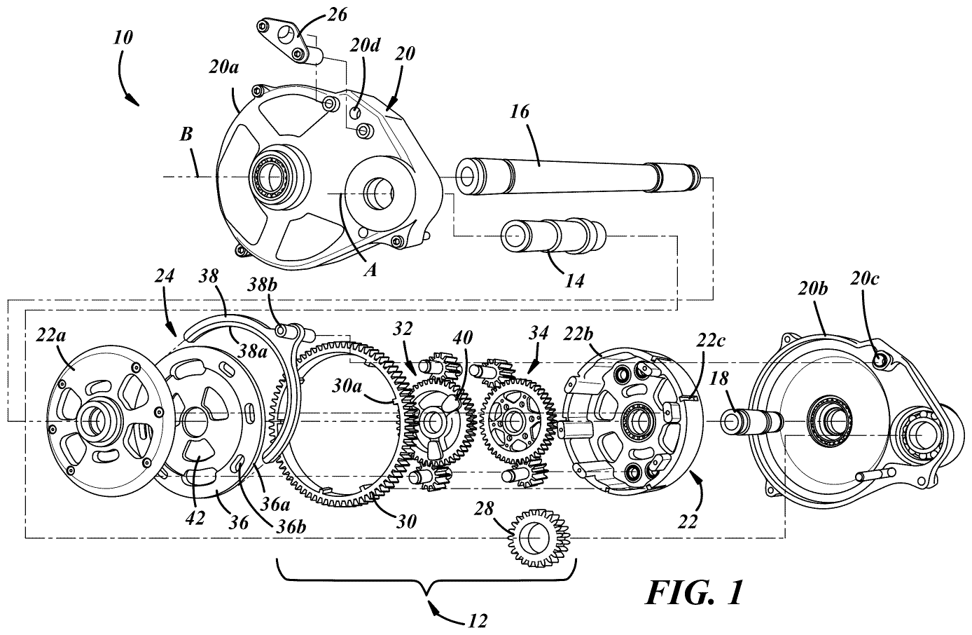

FIG. 1 is an exploded view of a spur-gear locking differential 10 having a gear train 12 in which every gear is a spur gear, resulting in an extremely low-profile differential useful in applications with limited packaging space. The gear train 12 operatively couples an input shaft 14 arranged along an input axis A to a first output shaft 16 and a second output shaft 18 arranged along a common output axis B such that power from the input shaft is transmitted to one or both of the output shafts. The differential 10 has an unlocked condition, in which the output shafts 16, 18 are permitted to rotate about the output axis B at different speeds, and a locked condition, in which the output shafts are restricted to rotate at the same speed.

The differential 10 further includes a housing 20, a carrier 22, and a locking mechanism 24. The illustrated housing 20 includes first and second portions 20a, 20b defining a hollow volume in which the gear train 12, the carrier 22, and the locking mechanism 24 are supported and housed. The housing 20 also defines the input and output axes A, B through respective shaft openings through which the input shaft 14 and output shafts 16, 18 extend and are rotatably coupled with via bearing assemblies. The housing 20 is configured for attachment to a vehicle or other machine and is a stationary component with respect to the component it is mounted to. A shifter bracket 26 is affixed to the outside of the housing 20 in this example.

The gear train 12 and carrier 22 are dynamic components that are each rotatable with respect to the housing 20 about the output axis B during use. The gear train 12 includes an input gear 28, a ring gear 30, a first set of planetary gears 32, and a second set of planetary gears 34. The locking mechanism 24 includes a lock 36 and a shifter 38. The carrier 22 includes first and second portions 22a, 22b defining a hollow volume in which the sets of planetary gears 32, 34 are housed and between which the lock 36 of the locking mechanism 24 is located.

The input gear 28 is affixed to a proximal end of the input shaft 14 within the housing 20 and rotates together with and at the same rotational speed as the input shaft. The input gear 28 is operatively coupled with the ring gear 30 such that the ring gear rotates about the output axis B when the input shaft and gear 14, 28 rotate about the input axis A. In this case, the input and ring gears 28, 30 are directly coupled with their respective teeth intermeshed. A ratio of the effective diameters of the input and ring gears 28, 30 defines a differential gear reduction ratio. The ring gear 30 in this case is affixed to the carrier 22 and rotates together with and at the same rotational speed as the carrier. In this example, the ring gear 30 has radially inwardly extending protrusions 30a that interlock with recesses or grooves 22c formed along an outer perimeter of one portion 22b of the carrier 20.

In this example, the lock 36 is a locking plate and is a dynamic component that is coupled with the carrier 22 and rotates together with and at the same rotational speed as the carrier and ring gear 30. The lock 36 is also moveable with respect to the carrier 22 between locked and unlocked positions. In this case, lock 36 movement is in the axial direction of the output axis B. The shifter 38 is also moveable with respect to the housing 20 and carrier 22 but does not rotate about the output axis B. The illustrated shifter 38 has a C-shape when viewed in the axial direction and extends circumferentially around a portion of the outer perimeter of the lock 36. A radially inner tongue 38a of the shifter 38 is received in a groove 36a extending along the outer perimeter of the lock 36 such that the shifter and lock are in constant contact, or at least such that the tongue 38a is always in the groove 36a.

Here, the shifter 38 is slidingly engaged with the housing 20 via a shaft 38b, one end of which is received in a recess or opening 20c in one portion 20b of the housing, and the other end of which is received in a corresponding recess or opening 20d of the other portion 20a of the housing. In this example, the end of the shaft 38b extends through the opening 20d to be coupled with an actuator, which can be a manual actuator (e.g., a lever and cable system) or a powered actuator (e.g., a solenoid or fluidic cylinder). Operation of the differential 10 and locking mechanism 24 will become apparent with reference to the subsequent figures.

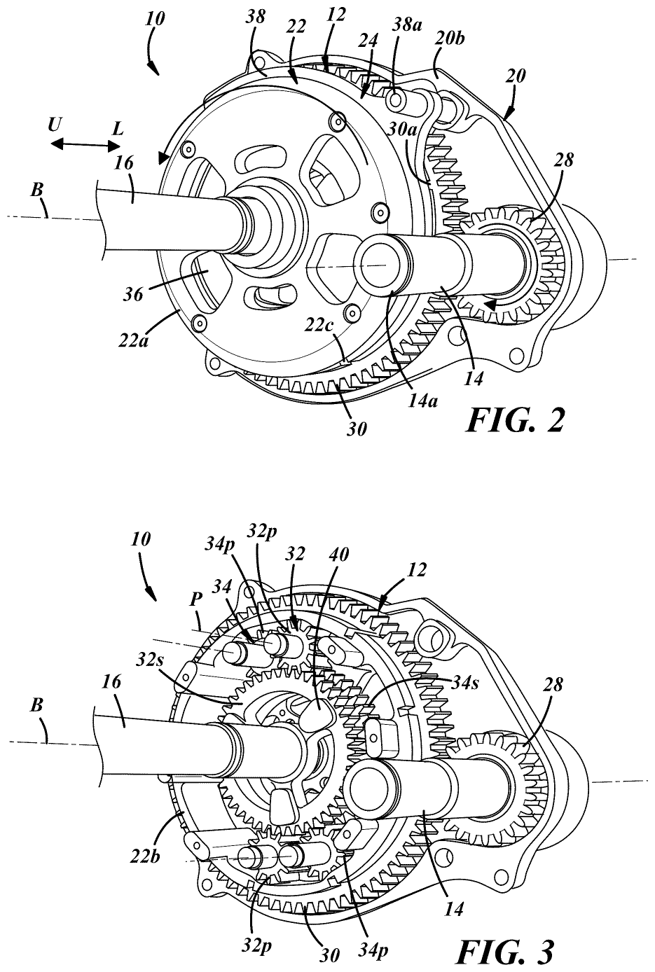

FIGS. 2 and 3 illustrate the locking differential 10 of FIG. 1 as assembled and with various components omitted in order to view otherwise hidden components. In FIG. 2, the first portion 20a of the housing 20 is omitted. Visible in FIG. 2 are the input shaft 14, the first output shaft 16, a portion of the gear train 12, a portion 22a of the carrier 22, and the shifter 38 of the locking mechanism 24. A proximal end (not visible) of the input shaft 14 is rotatably coupled with the second portion 20b of the housing 20 via a bearing assembly mounted in a recess of the housing portion, and a distal end 14a of the input shaft 14 extends through the omitted portion 20a of the housing 20. The input gear 28 is keyed, splined, or otherwise affixed to the input shaft 14 for co-rotation about the input axis A.

The input gear 28 is intermeshed with the ring gear 30 such that the two gears rotate in opposite directions about their respective axes A, B. The ring gear 30 is interlocked with the carrier 22 via the cooperating protrusions 30a and recesses 22c—which could be reversed with protrusions of the carrier being received by recesses of the ring gear. The carrier 22 can thus be driven about the output axis B via rotation of the input shaft 18 about the input axis A. The shifter 38 is non-rotating but is moveable between locked and unlocked positions via sliding engagement with the housing 20. The locking plate 36 is only partly visible in FIG. 2 through openings in the first portion 22a of the carrier 22. The relative axial directions of the locked (L) and unlocked (U) positions of the locking mechanism 24 are illustrated in FIG. 2.

In FIG. 3, the first carrier portion 22a and the locking mechanism 24 are additionally omitted so that the entire gear train 12 is visible, including the first and second sets of planetary gears 32, 34. Each set of planetary gears includes a sun gear 32s, 34s and at least one planet gear 32p, 34p. Each gear of the sets of planetary gears is a spur gear. In this example, each set 32, 34 includes two planet gears 32p, 34p circumferentially spaced about the respective sun gear 32s, 34s by 180 degrees. Each sun gear 32s, 34s is rigidly affixed to a proximal end of one of the output shafts 16, 18 such that each sun gear rotates together with its respective output shaft about the output axis B. The sun gears 32s, 34s may be referred to as drive gears since their rotation drives rotation of the output shafts 16, 18. The sun gears 32s, 34s are axially spaced within the carrier 22 and coupled together only by the planet gears 32p, 34p.

Each planet gear 32p, 34p is rotatable about a respective and distinct planet gear axis P and is carried by the carrier 22 such that it can orbit its respective sun gear 32s, 34s. Orbiting is another mode of planet gear rotation in which the planet gear axes P rotate about the output axis B in addition to or alternatively to the planet gears 32p, 34p rotating about their own planet axes. Specifically, each planet gear 32p, 34p is rigidly affixed to a planet gear shaft, the opposite ends of which are rotatably mounted to respective portions 22a, 22b of the carrier—e.g., via bearings pressed into the carrier portions. Accordingly, when the input shaft 14 is rotated about the input axis A and the carrier 22 is rotated in the opposite direction about the output axis B, all of the planet gears 32p, 34p orbit the output axis B together with the rotating carrier 22.

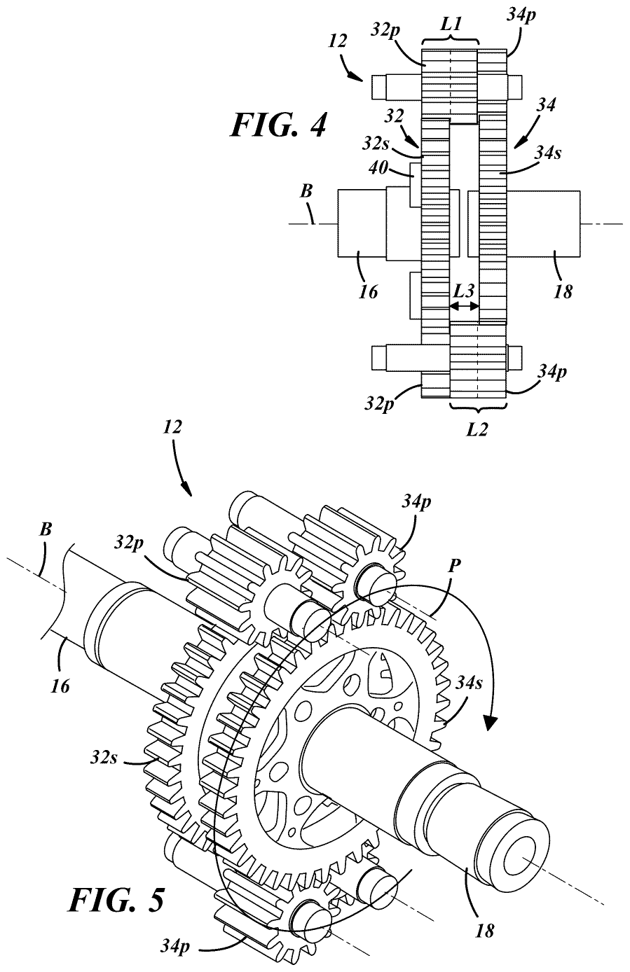

In addition to being intermeshed with its respective sun gear 32s, 34s, each planet gear 32p, 34p is also intermeshed with a planet gear of the other set of planetary gears. Specifically, each planet gear 32p of the first set of planetary gears 32 is intermeshed with its sun gear 32s and with one of the planet gears 34p of the second set of planetary gears 34. Similarly, each planet gear 34p of the second set of planetary gears 34 is intermeshed with its sun gear 34s and with one of the planet gears 32p of the first set of planetary gears 32. This is best illustrated in FIGS. 4 and 5, in which the carrier 22 is omitted.

The side view of FIG. 4 shows the sun gear 32s of the first set of planetary gears 32 fixed to the first output shaft 16 and the sun gear 34s of the second set of planetary gears 34 fixed to the second output shaft 18, each of which is rotatable about the drive axis B. The planet gears 32p, 34p are each intermeshed with their respective sun gears 32s, 34s. The thickness or axial length L1, L2 of each planet gear 32p, 34p is greater than that of the sun gears 32s, 34s. In this example, L1 and L2 are the same and approximately equal to the thickness of one of the sun gears 32s, 34s plus the axial distance L3 between opposing faces of the sun gears such that the first planet gears 32p and second planet gears 34p have an axial overlap approximately equal to L3. The planet gears 32p, 34p thus intermesh with each other with proper circumferential spacing along the carrier 22. This is perhaps shown more clearly in the isometric view of FIG. 5, in which pertinent features are labeled with the same reference numerals.

In the absence of the locking mechanism 24, or in the unlocked condition of the differential 10, this arrangement permits power from the input shaft 14 to be transferred to the output shafts 16, 18 while also permitting the output shafts to rotate at different rotational speeds. In particular, when the input shaft 14 is rotated in the direction indicated in FIG. 2 and the carrier 22 rotates in the opposite direction about the output axis B, the planet gears 32p, 34p orbit the output axis B in the direction illustrated in FIG. 5. When a vehicle equipped with the differential 10 is traveling in a straight line—perpendicular to the output axis B—such that the load on the output shafts 16, 18 is equal, each sun gear 32s, 34s is an output gear and rotates together with its associated output shaft at the same rotational speed as the carrier 22. In that scenario, each planet gear 32p, 34p is orbiting the output axis B but is not rotating about its own individual planet axis P—i.e., each planet gear is stationary with respect to the sun gears 32s, 34s. But, when the vehicle turns, the sun gears 32s, 34s and output shafts 16, 18 rotate at different speeds. In a theoretical example of a perfectly sharp right-hand turn, in which the second output shaft 18 is held stationary (not rotating about axis B), the second planet gears 34p are forced to rotate on their own axes P to orbit the second sun gear 34. This in-turn causes the intermeshed first planet gears 32p to rotate in the opposite direction about their own axes P, which transmits all of the rotation of the carrier 22 to the first sun gear 32s and, thereby, the first output shaft 16.

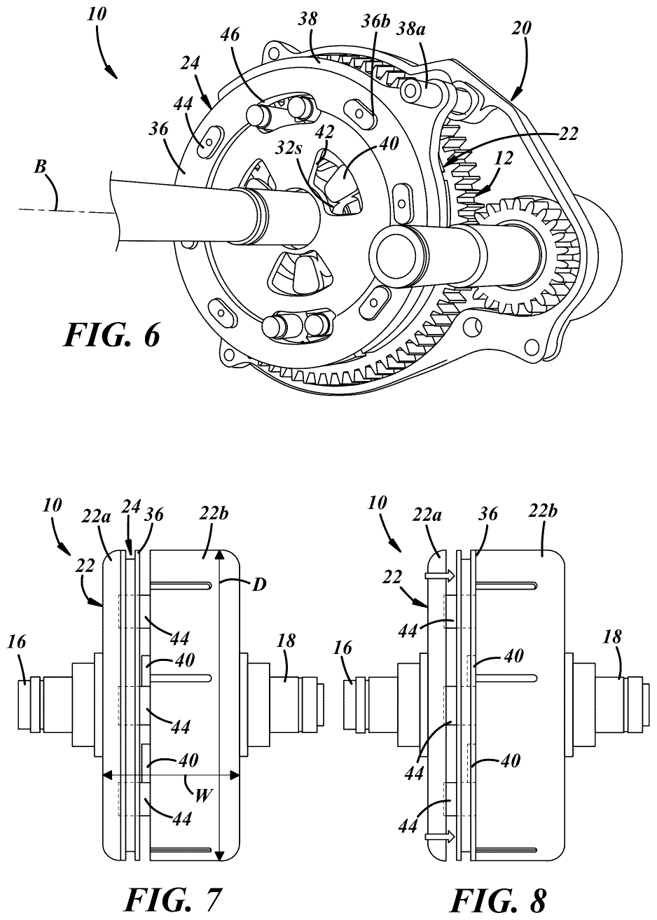

FIG. 6 is the same view of the differential 10 as in FIGS. 2 and 3, except the first portion 22a of the carrier 22 is omitted relative to FIG. 2 and the locking mechanism 24 is added relative to FIG. 3. As noted above, components of the locking mechanism 24 can be selectively moved between a locked position and an unlocked position. Specifically, the lock 36 of the locking mechanism 24 is movable between the unlocked position of FIG. 6 to a locked position. In this example, the lock 36 is a locking plate, and the movement of the locking plate is axial movement toward the gear train 12 to the locked position. As also noted above, this movement of the locking plate 36 can be effected by a shifter 38 engaged with the locking plate and slidingly engaged with the housing 20, such as via a shaft or sleeve 38a.

When the locking plate 36 is moved from the unlocked position and toward the gear train 12, it may engage a face of one of the sun gears 32s, 34s. In this example, the locking plate 36 engages a face of the first sun gear 32s. In particular, this engagement includes receiving a protrusion or dog 40 of one of the sun gears 32s into a corresponding slot 42 formed in the locking plate 36. The protrusion 40 and slot 42 could be reversed in position with protrusions of the locking plate 36 being received by slots in the sun gear 32s. It is also possible for both the locking plate 36 and the sun gear 32s to have protrusions, with the protrusions of one component located angularly between the protrusions of the other component in the locked position such that side walls of opposing protrusions provide the rotational locking function. The protrusion-and-slot arrangement may be preferred because it is more axially compact.

Here, the face of the sun gear 32s includes protrusions 40 that are received by slots 42 formed in the locking plate 36. The slots 42 in this case are openings formed through the locking plate 36, but the slots need not be formed entirely through the plate. The protrusions 40 are sized and shaped to fit within the slots 42—i.e. the radial and circumferential extents of the protrusions are smaller than those of the slots. The illustrative protrusions 40 are also labeled in FIGS. 1 and 3, and the slots 42 are labeled in FIG. 1. The circumferential dimension of each slot 42 may be from 1.1 to 3 times that of the protrusions 40 or preferably from 1.5 to 2.5 times that of the protrusions. In the illustrated example, the circumferential dimension of each protrusion 40 is about 30 degrees and that of the slots 42 is about 2 times greater, or about 60 degrees. The larger circumferential dimensions of the slots 42 relative to the protrusions 40 increases the probability that the lock 36 will immediately engage when actuated. The illustrated locking plate 36 is supported between the first and second portions 22a, 22b of the carrier 22 by one or more posts 44 extending between the first and second portions and through openings 36b formed through the plate. The posts 44 and through-openings 36b are sized and shaped to provide sliding movement of the looking plate 36 along the posts when the lock is moved between the locked and unlocked positions. The posts 44 thus serve a guiding function by defining the direction of movement of the locking plate 36 between the two portions of the carrier 22, and the openings 36b may be referred to as guide openings. The posts 44 also serve as attachment features by which the first and second portions 22a, 22b of the carrier are affixed together with the locking plate 36 between them.

With this arrangement, when the lock 36 is moved to the locked position and engages one of the sun gears 32s, the engaged sun gear is effectively locked into a stationary position with respect to the carrier 22—i.e., the output shaft 16 and sun gear 32s are forced to rotate about the output axis B at the same rotational speed as the carrier 22, and at the same rotational speed with which the planet gears 32p, 34p orbit the output axis. This means the first planet gears 32p are stationary with respect to the sun gear 32s—i.e., the planet gears 32p are not rotating on their own axes—which means the other planet gears 34p are also not rotating on their own axes, thus forcing the other sun gear 34s and output shaft 18 to rotate together with the first output shaft 16 as if the two output shafts were a solid axle.

It is specifically noted that the locked condition of the illustrated locking mechanism 24 is an interlocked condition in which there is mechanical and dimensional interference between two components with forces between the two components in the rotational direction. For purposes of this description, a friction-based locking condition such as a rotating clutch that relies on normal forces (perpendicular to the engaged surfaces) does not create an interlocked condition.

As is also apparent in FIG. 6, the planetary gear sets 32, 34 are packaged between one portion 22b of the carrier 22 and the lock 36. In order to accommodate the locking plate 36 between the two portions of the carrier 22, additional openings 46 may be provided through the plate for the planet gear shafts to extend fully between the two carrier portions 22a, 22b. The locking plate 36 may thus include a plurality of openings formed therethrough, with at least one of the openings 42 receiving a protrusion 40 of the engaged sun gear 32s in the locked position, at least one of the openings 36b having a guide post 44 extending therethrough, and at least one of the openings 46 having a shaft of one of the planet gears 32p, 34p extending therethrough.

FIGS. 7 and 8 are side views of a portion of the differential 10 illustrated in the unlocked condition in FIG. 7 and in the locked condition in FIG. 8. The shifter 38 of the locking mechanism 24 is omitted to clearly show the locking plate 36. The planet gear shafts and ring gear 30 are also omitted. In these views, axial spacing between the two portions 22a, 22b of the carrier 22 is apparent. The amount of spacing is approximately equal to the thickness of the locking plate 36 plus the axial thickness of the protrusions 40 on the sun gear 32s. In FIG. 7, the guide posts 44 holding the two carrier portions 22a, 22b together can be seen between the locking plate 36 and the second portion 22b. Broken lines indicate where the posts 44 extend through the plate 36 and are slightly recessed in the first carrier portion 22a. The sun gear protrusions 40 are also visible in FIG. 7 and are unengaged from the locking plate 36.

In FIG. 8, the locking plate 36 has been moved along the guide posts 44 to the locked position. The portions of the guide posts 44 visible in FIG. 7 are now hidden and shown in broken lines. The sun gear protrusions 40 are engaged with the lock 36 via the slots 42 in the locking plate shown in the previous figures and are shown in broken lines in FIG. 8.

It is noted that the axial gap between the carrier portions 22a, 22b is not strictly required. The locking plate 36 may for example have an outer perimeter that fits within the hollow space defined by the carrier 22, and the shifter 38 make take some other form. The plate form of the lock 36 is also not required. It is contemplated that other types of components can engage one of the sun gears 32s, 34s to effectively lock it to the carrier 22 and thereby cause the two sun gears and output shafts to move together as one.

A working example of the above-described locking differential 10 has been constructed and tested. The working example included a 23-tooth input gear 28 and a 78-tooth ring gear 30 for a 3.39 gear reduction ratio, converting a 53 ft-lb input torque to a maximum output torque of 180 ft-lb. The planetary gear sets 32, 34 included 40-tooth sun gears and 12-tooth planet gears. With reference to FIG. 7, the resulting differential 10, excluding the input shaft 14, output shafts 16, 18, and housing 20, had an axial dimension (W) of 1.89 ″ (48 mm), a diameter (D) of 4.4 ″ (112 mm), and a weight of 6.5 pounds and is more axially compact than a traditional spider-gear design having the same gear ratio and performance requirements.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A locking differential comprising a gear train operatively coupling an input shaft to first and second output shafts, the gear train comprising first and second spur gears fixed to the respective first and second output shafts such that the spur gears are permitted to rotate at different speeds when the differential is in an unlocked condition and are restricted to rotate at the same speed when the differential is in a locked condition.

2. The differential of claim 1, wherein the gear train includes a plurality of gears each transmitting power from the input shaft to the first and second spur gears, each gear of the plurality of gears being a spur gear.

3. The differential of claim 1, further comprising:
a first set of planetary gears including the first spur gear as a first sun gear and including a first planet gear intermeshed with the first sun gear;
a second set of planetary gears including the second spur gear as a second sun gear and including a second planet gear intermeshed with the second sun gear; and
a carrier operatively coupled with the input shaft,
wherein the carrier carries the first and second planet gears in orbit about an output axis of the differential when the input shaft rotates about an input axis of the differential,
wherein the first planet gear is intermeshed with the second planet gear, and
wherein each planet gear is a spur gear.

4. The differential of claim 3, further comprising a lock that is movable between an unlocked position, in which the first and second sun gears are permitted to rotate about the output axis independently from the carrier, and a locked position, in which the first and second sun gears are restricted to rotate about the output axis with the carrier.

5. The differential of claim 4, wherein the lock is movable between the unlocked and locked positions in an axial direction of the output shafts and engages a face of one of the sun gears in the locked position.

6. The differential of claim 4, wherein a face of one of the sun gears includes at least one protrusion received by a slot of the lock when the lock is in the locked position.

7. The differential of claim 6, wherein lock is a locking plate and the slot is formed through the locking plate.

8. The differential of claim 4, wherein the lock is movable along one or more guide posts between the unlocked and locked positions, each guide post rigidly interconnecting opposite first and second portions of the carrier.

9. The differential of claim 8, wherein the lock is a locking plate having one or more guide openings formed through the plate with each guide post extending through one of the guide openings.

10. The differential of claim 4, wherein the lock is a locking plate that rotates with the carrier about the output axis, the locking plate engaging one of the sun gears in the locked position and engaging neither of the sun gears in the unlocked position.

11. The differential of claim 10, further comprising a plurality of openings formed through the locking plate, at least one of the openings receiving a protrusion of the engaged sun gear in the locked position, at least one of the openings having a guide post extending therethrough, and at least one of the openings having a shaft of one of the planet gears extending therethrough.

12. The differential of claim 4, further comprising a shifter that moves the lock between the unlocked and locked position, wherein the lock rotates with the carrier and the shifter does not rotate with the lock or carrier.

13. The differential of claim 12, wherein the lock is a locking plate and the shifter is located at a perimeter of the locking plate and engages the locking plate at the perimeter to move the locking plate between the unlocked and locked positions.

14. The differential of claim 13, wherein the shifter has a C-shape when viewed in an axial direction of the output shafts and extends circumferentially around a portion of the perimeter of the locking plate.

15. The differential of claim 13, wherein a radially inner portion of the shifter is received in a groove extending along the perimeter of the locking plate.
